(19) United States
(12) Patent Application Publication
(10) Pub. No.: US 2006/0050905 A1
(43) Pub. Date: Mar. 9, 2006

(54) Sound detecting mechanism and process for manufacturing the same

(75) Inventors: Yoshiaki Ohbayashi, Nara-shi (JP); Mamoru Yasuda, Kobe-shi (JP); Shinichi Saeki, Kashiwara-shi (JP); Masatsugu Komai, Nishinomiya-shi (JP); Kenichi Kagawa, Kawasaki-shi (JP)

Correspondence Address: THE WEBB LAW FIRM, P.C., 700 KOPPERS BUILDING, 436 SEVENTH AVENUE, PITTSBURGH, PA, 15219, US

(73) Assignees: HOSIDEN CORPORATION, Osaka (JP); TOKYO ELECTRON LIMITED, Tokyo (JP)

(21) Appl. No.: 10/544,120

(22) PCT Filed: May 25, 2004
(86) PCT No.: PCT/JP04/07091

§ 371 Date: Aug. 2, 2005

(30) Foreign Application Priority Data
May 27, 2003 (JP) 2003-148919

(51) Int. Cl. H04R 25/00

(52) U.S. Cl. 381/175

(57) ABSTRACT

A sound detecting mechanism is provided which forms a diaphragm with a required thickness and yet restraining distortion of the diaphragm to provide high sensitivity.

The sound detecting mechanism comprises a pair of electrodes forming a capacitor on a substrate A in which one of the electrodes is a back electrode C forming perforations Ca therein corresponding to acoustic holes and the other of the electrodes is a diaphragm B. A silicon nitride film 303 is provided on the side adjacent a base of the substrate A with respect to a membrane acting as the diaphragm B formed on the substrate A.

### TECHNICAL FIELD

The present invention relates to a sound detecting mechanism and a manufacturing method thereof, in which the sound detecting mechanism comprises a pair of electrodes forming a capacitor on a substrate in which one of the electrodes is a back electrode forming perforations therein corresponding to acoustic holes and the other of the electrodes is a diaphragm.

### BACKGROUND ART

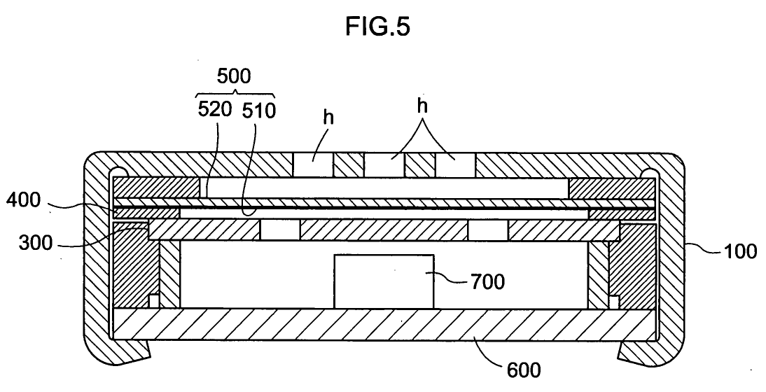

Conventionally, condenser microphones are frequently used in mobile phones, for example. A typical construction of condenser microphones is shown in FIG. 5. This condenser microphone comprises a metal capsule 100 including a plurality of perforations “h” corresponding to acoustic holes formed therein, a fixed electrode 300 and a diaphragm 500 provided inside the capsule to be opposed to each other with a spacer 400 therebetween to maintain a predetermined gap, a substrate 600 fixed and fitted to a rear opening of the capsule 100, and an impedance converting element 700 made of J-FET or the like and mounted to the substrate 600. With this type of condenser microphone, a high voltage is applied to a dielectric material formed on the fixed electrode 300 or the diaphragm 500 to be heated to generate electric polarization and produce an electret membrane allowing a residual electric charge to remain on a surface thereof (an electret membrane 510 is formed in a diaphragm body 520 made of metal or conductive film which constitutes the diaphragm 500 in FIG. 5), thereby to provide a construction that requires no bias voltage. When the diaphragm 500 is vibrated by sound pressure signals of a sound, a distance between the diaphragm 500 and the fixed electrode 300 is changed to vary capacitance. The variation of capacitance is outputted through the impedance converting element 700.

Another conventional sound detecting mechanism has the following construction. This sound detecting mechanism comprises a substrate (110) constituting a diaphragm and a substrate (108) constituting a back face plate (103) (corresponding to the back electrode of the present invention), both substrates being superimposed through an adhesive layer (109) and then adhered to each other through heat treatment. Then, the substrate (108) acting as the back face plate is ground to obtain a desired thickness. After an etching mask (112) is formed on each of the substrates (108) and (109), the substrates are treated with an alkali etching liquid thereby to obtain the diaphragm (101) and the back face plate (103). Next, the back face plate (103) is reticulated (corresponding to the perforations of the present invention). An insulating layer (111) is etched with hydrofluoric acid, with the back face plate (103) acting as an etching mask, thereby to form a void layer (104) (see Patent Document 1, for example: the reference numbers are quoted from the cited document.)

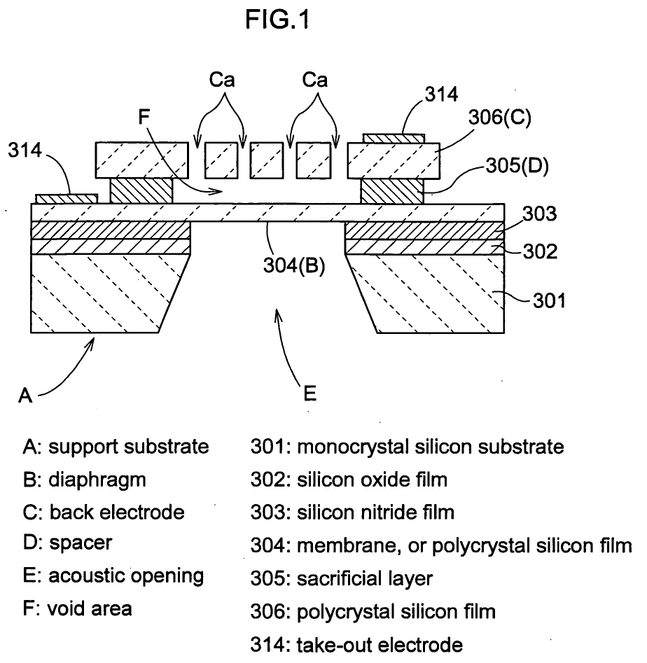

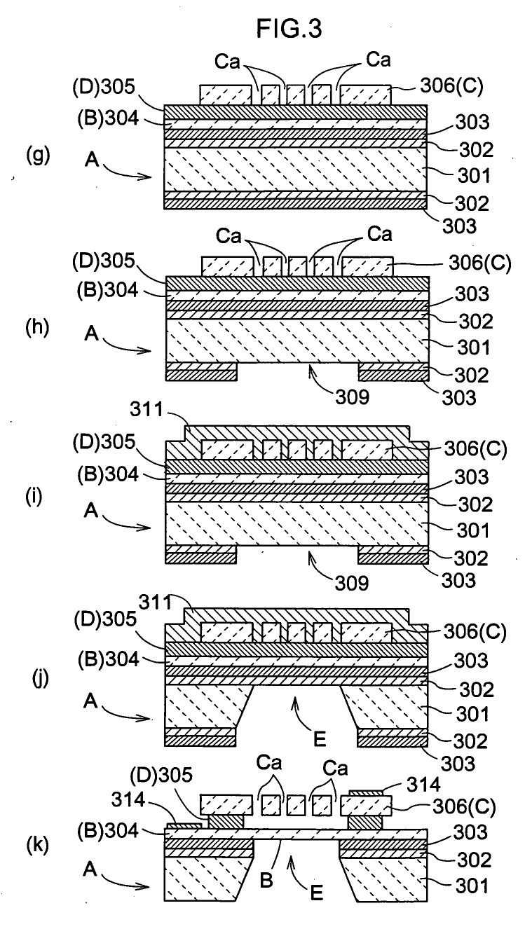

Patent Document 1: Japanese Patent Publication No. 2002-27595 (paragraph [0030] through [0035], FIG. 1 and FIG. 3).

### DISCLOSURE OF THE INVENTION

Problem to be Solved by the Invention

In order to increase output (improve sensitivity) of the conventional microphone shown in FIG. 5, it is required to increase the capacitance between the fixed electrode 300 and the diaphragm 500. In order to increase the capacitance, an area of superimposition area of the fixed electrode 300 and the diaphragm 500 should be increased. Alternatively, it will be effective to reduce the gap between the fixed electrode 300 and the diaphragm 500. However, an increase in the area of superimposition of the fixed electrode 300 and the diaphragm 500 would lead to an enlargement of the microphone per se. On the other hand, in the construction having the spacer 400 noted above, there is a limitation in reducing the distance between the fixed electrode 300 and the diaphragm 500.

Also, the electret condenser microphones often utilize a high polymeric organic substance such as FEP (Fluoro Ethylene Propylene) or the like in order to produce a permanent electric polarization. The microphone using such a high polymeric organic substance has poor heat resistance, and thus is hardly capable of enduring the heat in time of re-flow treatment when mounted on a printed board, for example. The microphone, therefore, cannot be given re-flow treatment when mounted on the printed board or the like.

In view of the above, as described in Patent Document 1, it is conceivable to employ a construction including a back electrode and a diaphragm formed on a silicon substrate by micro fabrication technique. A sound detecting mechanism having such a construction is compact and yet is capable of enhancing sensitivity by reducing the distance between the back electrode and the diaphragm. Further, the mechanism can undergo re-flow treatment while requiring a bias supply. However, according to the technique set forth in Patent Document 1, the diaphragm is formed by etching a monocrystal silicon substrate with an alkali etching liquid, which makes it difficult to control the thickness of the diaphragm. As a result, it is difficult to obtain a required thickness for the diaphragm.

In considering control of the thickness of the diaphragm here, it is effective to utilize an SOI wafer to improve the controllability of the thickness of the diaphragm in the process of forming the diaphragm by etching the silicon substrate with the alkali etching liquid. More particularly, according to this method, a built-in oxide film of the SOI wafer can be utilized as a stop layer for etching with the alkali etching liquid, thereby to control the thickness of the diaphragm by selecting the thickness of an active layer of the SOI wafer.

Nonetheless, even with such a method, an internal stress generating from the built-in oxide film or the like distorts the diaphragm, which deteriorates the vibration characteristic when the diaphragm is formed with a reduced thickness. If the thickness of the diaphragm is selected in order to reduce the distortion caused by the internal stress, it is required to increase the thickness of the diaphragm more than necessary. Thus, the diaphragm cannot have a reduced thickness but merely extends the process (merely increases processing loads), which leaves room for improvement.

The object of the present invention is to provide a rational construction for a sound detecting mechanism having a diaphragm formed with a required thickness and yet restraining distortion of the diaphragm to provide high sensitivity.

Means for Solving the Problem

The first characteristic feature of a sound detecting mechanism according to the present invention lies in comprising a pair of electrodes forming a capacitor on a substrate in which one of the electrodes is a back electrode forming perforations therein corresponding to acoustic holes and the other of the electrodes is a diaphragm, wherein a silicon nitride film is provided on the side adjacent a base of the substrate with respect to a membrane acting as the diaphragm formed on the substrate.

[Function and Effect]

According to the above-noted construction, the membrane acting as the diaphragm is formed on an external surface of the silicon nitride film. Thus, under the condition where the substrate is removed by etching to expose the membrane forming the diaphragm, even when stress acts on the membrane from the substrate, the silicon nitride film releases the stress to restrain the phenomenon that allows an unnecessary stress to act on the diaphragm or the phenomenon that distorts the diaphragm, thereby to vibrate the diaphragm faithfully to sound pressure signals. Further, the above-noted characteristic feature provides the construction that dispenses with an electret layer and is capable of enduring the heat in time of re-flow treatment when mounted on a printed board. As a result, the sound detecting mechanism having high sensitivity can be provided by a very simple improvement in construction for forming the silicon nitride film between the membrane constituting the diaphragm and the support substrate. In particular, according to this arrangement, the compact sound detecting mechanism can be provided on the support substrate by utilizing micro fabrication technique, which allows the mechanism to be used easily in small devices such as mobile phones and to undergo the re-flow treatment when mounted on the printed board.

The second characteristic feature of the sound detecting mechanism according to the present invention lies in that the substrate includes a support substrate having a monocrystal silicon substrate acting as the base thereof, wherein an SOI wafer having the silicon nitride film held between an active layer and a built-in oxide film layer is used as the support substrate whereby the active layer forms the diaphragm.

[Function and Effect]

According to the above-noted construction, necessary treatment such as etching or the like is executed on the SOI wafer having the monocrystal silicon substrate acting as the base, thereby to form the sound detecting mechanism utilizing the active layer as the diaphragm, for example. Even when stress acts on the diaphragm, the silicon nitride film releases the stress. As a result, the SOI wafer having the necessary membrane already formed therein is used to readily provide the sound detecting mechanism.

The third characteristic feature of the sound detecting mechanism according to the present invention lies in that the substrate includes a support substrate having a monocrystal silicon substrate acting as the base thereof, wherein an SOI wafer having the silicon nitride film held between a built-in oxide film layer and the base is used as the support substrate.

[Function and Effect]

According to the above-noted construction, necessary treatment such as etching or the like is executed on the SOI wafer having the monocrystal silicon substrate acting as the base, thereby to form the sound detecting mechanism utilizing the membrane formed on an external surface of the built-in oxide film as the diaphragm, for example. Even when stress acts on the diaphragm, the silicon nitride film releases the stress. As a result, the SOI wafer having the necessary membrane already formed therein is used to readily provide the sound detecting mechanism.

The fourth characteristic feature of the sound detecting mechanism according to the present invention lies in that the substrate includes a support substrate having a monocrystal silicon substrate, wherein a silicon oxide film is formed on the support substrate, the silicon nitride film is formed on the silicon oxide film, and a silicon film is further formed on the silicon nitride film.

[Function and Effect]

According to the above-noted construction, the substrate having the silicon oxide film, the silicon nitride film and the silicon film (either of monocrystal silicon and polycrystal silicon is applicable) formed thereon in this order is used for the monocrystal silicon substrate acting as the support substrate, and necessary treatment is executed, thereby to form the sound detecting mechanism utilizing the silicon film as the diaphragm. Even when stress acts on the diaphragm, the silicon nitride film releases the stress. As a result, treatment for forming the films on the monocrystal silicon substrate and treatment for removing the films of specified portions are executed thereby to provide the sound detecting mechanism.

The fifth characteristic feature of the sound detecting mechanism according to the present invention lies in that the substrate includes a support substrate having a monocrystal silicon substrate acting as the base thereof, wherein a laminated layer consisting of a silicon oxide film and the silicon nitride film is formed between the membrane acting as the diaphragm and the support substrate, wherein the thickness of the silicon nitride film is selected within the range of 0.1 μm through 0.6 μm, and wherein a film thickness ratio, (silicon oxide film)/(silicon nitride film)=R, is determined as 0<R<=4.

[Function and Effect]

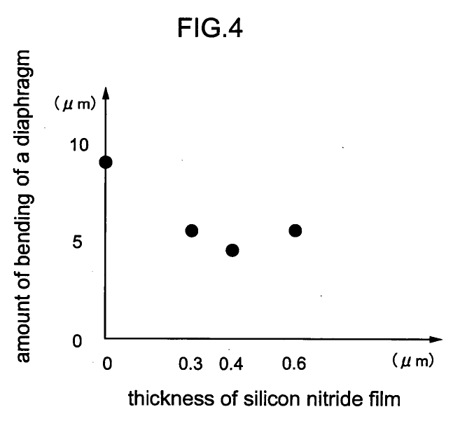

According to the above-noted construction, combined stress of the laminated layer consisting of the silicon oxide film and the silicon nitride film is controlled by selecting the thickness of the silicon oxide film and the thickness of the silicon nitride film, thereby to control stress acting from the monocrystal silicon substrate on the diaphragm to control stress acting on the diaphragm. FIG. 4 shows experimental results for proving the controllability of stress acting on the diaphragm in this way. Specifically, under the condition where the thickness of the diaphragm is determined as 2 μm and the thickness of the silicon nitride film is varied to manufacture the condenser microphone, amounts of bending of the diaphragm are reduced in the respective cases, compared with the construction having no silicon nitride film, as apparent from the drawing. The thickness of the silicon nitride film is selected to fall within the range of 0.1 μm to 0.6 μm, and the film thickness ratio, (silicon oxide film)/(silicon nitride film)=R, is determined as 0<R<=4, thereby to maintain the amounts of bending of the diaphragm in a small value of 6 μm or less. As a result, the amounts of bending of the diaphragm can be reduced by selecting the thickness of the silicon oxide film and the thickness of the silicon nitride film, thereby to provide the sound detecting mechanism that can be used without a hitch.

The sixth characteristic feature of the sound detecting mechanism according to the present invention lies in that a silicon substrate of (100) orientation is used as the monocrystal silicon substrate.

According to the above-noted construction, it is possible to promote etching selectively in a direction of the orientation peculiar to the monocrystal silicon substrate of (100) orientation, which allows for fine etching faithful to an etching pattern. As a result, a shape processing required by precise machining can be realized.

The seventh characteristic feature of the sound detecting mechanism according to the present invention lies in that impurity diffusion treatment is executed on the diaphragm.

[Function and Effect]

According to the above-noted construction, impurity diffusion treatment is executed on the diaphragm, which makes it possible to produce compressed stress relative to the diaphragm and allow the compressed stress to be exerted in a direction to cancel stress acting on the diaphragm from the monocrystal silicon substrate. As a result, the stress acting on the diaphragm can be further reduced to provide the sound detecting mechanism of high sensitivity.

The characteristic feature of a method of manufacturing a sound detecting mechanism according to the present invention lies in manufacturing the sound detecting mechanism comprising a pair of electrodes forming a capacitor on a monocrystal silicon substrate in which one of the electrodes is a back electrode forming perforations therein corresponding to acoustic holes and the other of the electrodes is a diaphragm, the method comprising the steps of forming a silicon oxide film on a top surface of the monocrystal silicon substrate, forming a silicon nitride film on the silicon oxide film, forming a polycrystal silicon film acting as the diaphragm on the silicon nitride film, forming a silicon oxide film acting as a sacrificial layer on the polycrystal silicon film, forming a polycrystal silicon film acting as the back electrode on the silicon oxide film, forming a pattern of the polycrystal silicon film acting as the back electrode in a desired shape by photolithographic technique, removing an area extending from the back side of the monocrystal silicon substrate to a lower portion of the diaphragm by etching, removing the silicon oxide film and the silicon nitride film present in the lower portion of the diaphragm by hydrofluoric acid, and removing the silicon oxide film acting as the sacrificial layer.

[Function and Effect]

According to the above-noted construction, the silicon oxide film, the silicon nitride film, the polycrystal silicon film acting as the diaphragm, the silicon oxide film acting as the sacrificial layer, and the silicon oxide film acting as the back electrode, are formed on the top surface of the monocrystal silicon substrate in this order, and then etching is executed by photolithographic technique, thereby to manufacture the sound detecting mechanism. As a result, it is possible to form a small capacitor on the monocrystal silicon substrate to provide the sound detecting mechanism merely by using the conventional existing technique for forming a semiconductor on the silicon substrate.

Best Mode for Carrying Out the Invention

An embodiment of the present invention will be described hereinafter with reference to the drawings.

FIG. 1 is a sectional view of a silicon condenser microphone (simply referred to as a microphone hereinafter) exemplifying a sound detecting mechanism of the present invention. The microphone comprises a support substrate A having a base of monocrystal silicon, a diaphragm B and a back electrode C formed on the support substrate A from polycrystal silicon film made by LP-CVD (Low Pressure Chemical Vapor Deposition) technique, and a sacrificial layer made of silicon oxide film (SiO₂) and arranged between the diaphragm B and the back electrode C to act as spacer D. This microphone allows the diaphragm B and the back electrode C to function as a capacitor, which is used to electrically take out variations of capacitance of the capacitor when the diaphragm B is vibrated by sound pressure signals.

The support substrate A in this microphone has a size of a square with one side 5.5 mm in length and around 600 μm in thickness. The diaphragm B has a size of a square with one side 2.0 mm in length and around 2 μm in thickness. The back electrode C has a plurality of perforations Ca formed therein corresponding to acoustic holes, each having a square with one side around 10 μm in length. In FIG. 1, the thickness of part of the films or layers is shown in an exaggerated way.

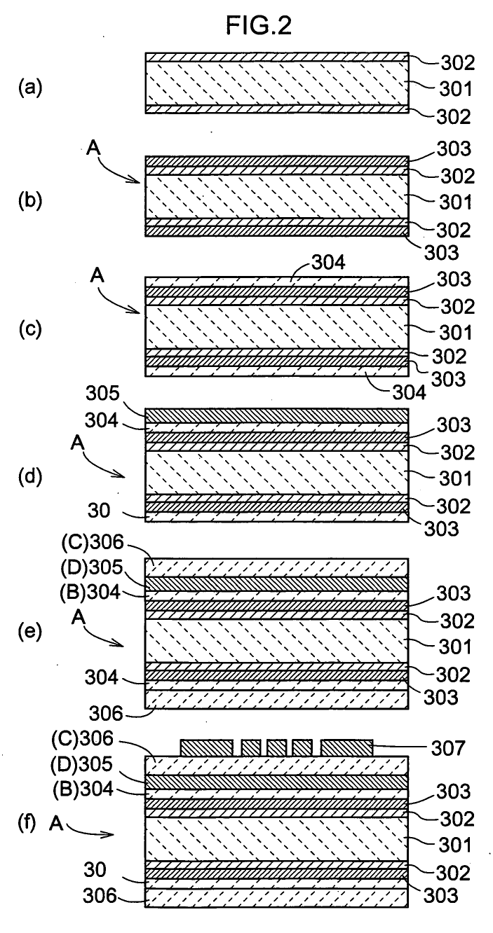

The microphone is formed by laminating a silicon oxide film 302, a silicon nitride film 303, a polycrystal silicon film 304, a sacrificial layer 305 and a polycrystal silicon film 306 on a top surface of a monocrystal silicon substrate 301. The top polycrystal silicon film 306 undergoes etching to form the back electrode C and the plurality of perforations Ca. Further, etching is executed on a portion extending from the back surface of the monocrystal silicon substrate 301 through the polycrystal silicon film 304 (one example of membranes constituting the diaphragm B) to form an acoustic opening E. The diaphragm B is formed by the polycrystal silicon film 304 exposed to the portion of the acoustic opening E, and further the sacrificial layer 305 undergoes etching to define a void area F between the diaphragm B and the back electrode C. The spacer D is formed by the sacrificial layer 305 remaining at outer peripheral portions of the diaphragm B after the etching. Steps for manufacturing (a method of manufacturing) the microphone will be described based on FIGS. 2(a) through 2(f), and FIGS. 3(g) through 3(k).

Step (a): The silicon oxide films 302 of 0.8 μm in thickness are formed on opposite surfaces of the monocrystal substrate 301 of (100) orientation by thermal oxidation. This silicon oxide film 302 functions as a stop layer for etching with an alkali etching liquid as described later. The thickness of the silicon oxide film 302 is not limited to 0.8 μm. More particularly, in relation to the thickness of the silicon nitride film 303 to be formed in the next step (b), it is preferable to provide a construction such that a film thickness ratio, (silicon oxide film)/(silicon nitride film)=R, may be 0<R<=4. Further, it is more preferable under such a condition to determine the thickness of the silicon oxide film 302 as 2 μm or less.

Step (b): The silicon nitride films 303 of 0.2 μm in thickness which function as stress releasing layers are formed on film surfaces of the silicon oxide films 302 formed in the step (a) (opposite surfaces of the substrate) by LP-CVD (Low Pressure Chemical Vapor Deposition) technique. The construction formed in this way represents the support substrate A consisting of an SOI wafer. The thickness of the silicon nitride film 303 is not limited to 0.2 μm, but may fall within the range of 0.1 μm through 0.6 μm.

Step (c): The polycrystal silicon films 304 are formed on surfaces of the silicon nitride films 303 of the support substrate A formed in the step (b) (opposite faces of the substrate) through the LP-CVD (Low Pressure Chemical Vapor Deposition) technique. Part of the polycrystal silicon film 304 formed in such a way functions as the diaphragm B. It is also possible to form a monocrystal silicon film, instead of the polycrystal silicon film 304, such that part of the monocrystal silicon film may be used as the diaphragm B.

Step (d): The silicon oxide film 305 functioning as the sacrificial layer of 5 μm in thickness is formed on a top surface of one of the polycrystal silicon films 304 (the upper one in the drawings) formed in the step (c) by P-CVD (Plasma Chemical Vapor Deposition) technique.

Step (e): Next, the polycrystal silicon films 306 of 4 μm in thickness are formed on the surface of the silicon oxide film 305 formed in the step (d) and on the opposite side thereof (on the surface of the polycrystal silicon film 304) by P-CVD technique.

Step (f): Photoresist is applied to the surface of the upper polycrystal silicon film 306 formed in the step (e), and a resist pattern 307 is formed by removing unwanted portions by photolithographic technique.

Step (g): Etching is executed by RIE (Reaction Ion Etching) technique, using the resist pattern 307 formed in the step (f) as a mask, to form a pattern of the back electrode C from the upper polycrystal silicon film 306 (patterning). The plurality of perforations Ca are simultaneously formed when the pattern of the back electrode C is formed in this way. Also, the back side (lower side in the drawings) polycrystal silicon films 306 and 304 are removed by executing etching in this way.

Step (h): Next, photoresist is applied to the surface of the back side (lower side in the drawings) silicon nitride film 303 to form a resist pattern by removing unwanted portions by photolithographic technique. Then, etching is executed by RIE (Reaction Ion Etching) technique, using the resist pattern as a mask, to remove the silicon nitride film 303 and the silicon oxide film 302 which is an inner layer of the film 303. This produces an opening pattern 309 for silicon etching which realizes etching by the alkali etching liquid executed in a step (j) described later.

Step (i): Next, a silicon nitride film 311 is formed on the top side (the side where the back electrode C is formed in the step (g)) which acts as a protecting film.

Step (j): Next, anisotropic etching is executed from the back side using a water solution of TMAH (tetramethylammonium-hydroxide) as an etching liquid to remove the silicon oxide film 303, thereby to form the acoustic opening E. In this etching process, since the rate of etching the silicon oxide film 302 (build-in oxide film) is sufficiently lower than the rate of etching the monocrystal silicon substrate 301, the silicon oxide film 302 functions as the stop layer for silicon etching.

Step (k): Next, the nitride film 311 formed as the protective layer, the sacrificial layer 305, the silicon oxide film 302 and the silicon nitride film 303 exposed to the acoustic opening E are removed. Further, the silicon nitride film 303 and the silicon oxide film 302 remaining on the back side of the monocrystal silicon substrate 301 are removed by etching with HF (hydrogen fluoride). This results in the diaphragm B formed by the polycrystal silicon film 304, the void area F formed between the diaphragm B and the back electrode C, and the spacer D formed by the remaining sacrificial layer 305. Subsequently, Au (gold) is vapor-deposited to desired positions using a stencil mask to form a take-out electrode 314, thereby to complete the microphone.

Various condenser microphones are made in accordance with the above process, maintaining the thickness of the diaphragm B in 2 μm and varying the silicon nitride film 303 acting as the stress releasing layer to the thicknesses of 0 (no silicon nitride film), 0.3 μm, 0.4 μm and 0.6 μm, respectively. FIG. 4 shows results of measuring amounts of bending of the diaphragm B by a laser displacement gauge. As shown, it can be understood that the bending amounts of the diaphragm B are restrained when the silicon nitride film 303 is provided, which means that the diaphragm B is restrained from bending by the silicon nitride film 303.

As described above, the sound detecting mechanism according to the present invention employs the construction including the diaphragm B and the back electrode C formed on the support substrate A by utilizing micro fabrication technique. As a result, the entire sound detecting mechanism may be made quite compact and readily incorporated to small devices such as mobile phones. Moreover, it is capable of enduring re-flow treatment at high temperature when it is mounted on a printed board, which makes it easy to assemble the apparatus.

In particular, the stress releasing layer consisting of the silicon nitride film is formed in a position adjacent the membrane forming the diaphragm B, thereby to contain stress acting on the diaphragm B and eliminate distortion of the diaphragm B, which can realize the sound detecting mechanism that produces vibrations precisely corresponding to sound pressure signals. Further, according to the sound detecting mechanism of the present invention, the stress releasing layer is formed only by such a simple improvement of the process as adding one step when the microphone is manufactured, for example, which prevents the manufacturing process from becoming complicated. In addition, the stress acting on the diaphragm can be restrained by forming the stress releasing layer, which can reduce the thickness of the diaphragm B to provide the sound detecting mechanism having an extremely high level of sensitivity.

### Modified Embodiments

Apart from the above-described embodiment, the present invention may be implemented as follows (common reference numbers and signs being used for the components in the following modified embodiments that have the same functions as in the foregoing embodiment).

(1) As the support substrate A, an SOI wafer is used that includes the silicon nitride film held between an active layer and a built-in oxide film. When employing this type of SOI wafer, it is possible to provide a sound detecting mechanism using the active layer as the diaphragm in which the silicon nitride film releases stress even when the stress acts on the diaphragm.

(2) As the support substrate A, an SOI wafer is used that includes the silicon nitride film held between an oxide film layer and the base of the support substrate. When employing this type of SOI wafer, it is possible to use the membrane formed on an external surface of the built-in oxide film as the diaphragm, for example, in which the silicon nitride film releases stress even when the stress acts on the diaphragm.

(3) In the foregoing embodiment, the silicon oxide film 302 is formed on the monocrystal silicon substrate 301, and then the silicon nitride film 303 is formed on the silicon oxide film 302. Alternatively, the silicon nitride film 303 may be formed on the monocrystal silicon substrate 301 first, and then the silicon oxide film 302 may be formed on the silicon nitride film 303. Also, it is desirable from the viewpoint of stress releasing that the thickness of the silicon nitride film 303 is selected within the range of 0.1 μm through 0.6 μm and that the film thickness ratio, (silicon oxide film)/(silicon nitride film)=R, is 0<R<=4.

(4) In the foregoing embodiment, the polycrystal silicon film 304 is used as a material for the diaphragm B. The material of the diaphragm B may be a membrane having conductivity such as a metal film, or a laminated film consisting of a membrane having conductivity such as a metal film and an electrical insulating membrane such as a resin film. Specifically, it may be possible to use a high melting point material including tungsten as the metal membrane.

(5) As described above, the present invention is aimed at reducing (restraining) the stress acting on the diaphragm B by forming the silicon nitride film 311. In addition to the construction forming the silicon nitride film 311 in this way, the stress acting on the diaphragm B may also be controlled by applying impurity diffusion to the diaphragm B. In one specific example of such treatment, boron is introduced into a vibrating diaphragm by ion implantation technique with the energy of 30 kV, a dose of 2E16 cm⁻². Heat treatment is executed at 1150° C. in a nitrogen atmosphere for eight hours as an activated heat treatment, thereby to form the diaphragm B having the compressed stress. Therefore, by combination of the film thickness ratio between the silicon oxide film and the silicon nitride film acting as the stop layer for silicon etching by the alkali etching liquid with impurity diffusion as well as the thickness of the back electrode, the tensile force of the diaphragm B is synthetically controlled to reduce an external force acting on the diaphragm B.

(6) It is also possible to form an integrated circuit on the support substrate A constituting the sound detecting mechanism. The integrated circuit functions to convert variations of capacitance between the diaphragm B and the back electrode C into electric signals for output. With the construction having such an integrated circuit, there is no need to form an electric circuit on the printed board or the like for converting variations of capacitance between the diaphragm B and the back electrode C into electric signals for output. This can minimize the size of the device utilizing the sound detecting mechanism having the arrangement of the present invention and simplify the construction.

### INDUSTRIAL UTILITY

According to the present invention, it is possible to provide a sound detecting mechanism which forms a diaphragm with a required thickness and yet restraining distortion of the diaphragm to provide high sensitivity. This sound detecting mechanism may also be used as a sensor responding to variations in aerial vibration and air pressure other than as a microphone.

### BRIEF DESCRIPTION OF THE DRAWINGS

[FIG. 1] A sectional view of a condenser microphone.

[FIG. 2] Views consecutively showing steps for manufacturing the condenser microphone.

[FIG. 3] Views consecutively showing steps for manufacturing the condenser microphone.

[FIG. 4] A graphic representation showing a relationship between thickness of silicon nitride film and amount of bending of a diaphragm.

[FIG. 5] A sectional view of a conventional condenser microphone.

### DESCRIPTION OF THE REFERENCE SIGNS

| | |
|---|---|
| 301 | monocrystal silicon substrate |
| 302 | silicon oxide film |
| 303 | silicon nitride film |
| 304 | membrane, or polycrystal silicon film |
| 305 | sacrificial layer |
| 306 | polycrystal silicon film |
| A | support substrate |
| B | diaphragm |
| C | back electrode |
| Ca | perforations |

1-8. (canceled)

9. A sound detecting mechanism comprising a pair of electrodes forming a capacitor on a substrate in which one of the electrodes is a back electrode forming perforations therein corresponding to acoustic holes and the other of the electrodes is a diaphragm, wherein a silicon nitride film is provided on a side adjacent a base of the substrate with respect to a membrane acting as the diaphragm formed on the substrate.

10. The sound detecting mechanism of claim 9, wherein the substrate includes a support substrate having a monocrystal silicon substrate acting as the base thereof, wherein an SOI wafer having the silicon nitride film held between an active layer and a built-in oxide film layer is used as the support substrate whereby the active layer forms the diaphragm.

11. The sound detecting mechanism of claim 9, wherein the substrate includes a support substrate having a monocrystal silicon substrate acting as the base thereof, wherein an SOI wafer having the silicon nitride film held between a built-in oxide film layer and the base is used as the support substrate.

12. The sound detecting mechanism of claim 9, wherein the substrate includes a support substrate having a monocrystal silicon substrate, wherein a silicon oxide film is formed on the support substrate, the silicon nitride film is formed on the silicon oxide film, and a silicon film is further formed on the silicon nitride film.

13. The sound detecting mechanism of claim 9, wherein the substrate includes a support substrate having a monocrystal silicon substrate acting as the base thereof, wherein a laminated layer consisting of a silicon oxide film and the silicon nitride film is formed between the membrane acting as the diaphragm and the support substrate, wherein the thickness of the silicon nitride film is selected within a range of 0.1 μm through 0.6 μm, and wherein a film thickness ratio, (silicon oxide film)/(silicon nitride film)=R, is determined as 0<R<=4.

14. The sound detecting mechanism of claim 10, wherein a silicon substrate of orientation is used as the monocrystal silicon substrate.

15. The sound detecting mechanism of claim 9, wherein the impurity diffusion treatment is executed on the diaphragm.

16. A method of manufacturing a sound detecting mechanism comprising a pair of electrodes forming a capacitor on a monocrystal silicon substrate in which one of the electrodes is a back electrode forming perforations therein corresponding to acoustic holes and the other of the electrodes is a diaphragm, the method comprising the steps of:
a) forming a silicon oxide film on a top surface of the monocrystal silicon substrate;
b) forming a silicon nitride film on the silicon oxide film;
c) forming a polycrystal silicon film acting as the diaphragm on the silicon nitride film;
d) forming a silicon oxide film acting as a sacrificial layer on the polycrystal silicon film;
e) forming a polycrystal silicon film acting as the back electrode on the silicon oxide film;
f) forming a pattern of the polycrystal silicon film acting as the back electrode in a desired shape by photolithographic technique;
g) removing an area extending from the back side of the monocrystal silicon substrate to a lower portion of the diaphragm by etching;
h) removing the silicon oxide film and the silicon nitride film present in the lower portion of the diaphragm by hydrofluoric acid; and
i) removing the silicon oxide film acting as the sacrificial layer.

17. The sound detecting mechanism of claim 11, wherein a silicon substrate of orientation is used as the monocrystal silicon substrate.

18. The sound detecting mechanism of claim 12, wherein a silicon substrate of orientation is used as the monocrystal silicon substrate.

19. The sound detecting mechanism of claim 13, wherein a silicon substrate of orientation is used as the monocrystal silicon substrate.
